(19) United States
(12) Patent Application Publication
(10) Pub. No.: US 2007/0140319 A1
(43) Pub. Date: Jun. 21, 2007

(54) Method and apparatus for transmitting wireline single-band orthogonal frequency division mutiplexing based ultra wideband signal over pipeline carrying CATV broadcasting signal

(75) Inventors: Keun-joo Park, Yongin-si (KR); Kwanghoon Kim, Daejeon (KR); Hyuncheol Park, Daejeon (KR); Yusung Lee, Daejeon (KR); June-koo Rhee, Daejeon (KR); Hyun-chin Kim, Seongnam-si (KR); Joonhyuk Kang, Daejeon (KR); Junkyu Lee, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/444,342

(22) Filed: Jun. 1, 2006

(30) Foreign Application Priority Data
Dec. 21, 2005 (KR) 10-2005-0127214

(51) Int. Cl. H04B 1/00

(52) U.S. Cl. 375/130

(57) ABSTRACT

A method and an apparatus for transmitting a single-band orthogonal frequency division multiplexing (OFDM)-based ultra wideband (UWB) signal over a pipeline carrying a cable television broadcasting signal. The method includes transforming a multimedia signal transmitted from a multimedia device into a wireline UWB signal; transforming the wireline UWB signal into a single-band OFDM signal; and frequency-spreading the single-band OFDM signal according to a transmission rate. Thus, the apparatus can be robust to multi-path interference and extend transmission distance so as to increase transmission efficiency.

### CROSS-REFERENCE TO RELATED APPLICATIONS

This application claims priority from Korean Patent Application No. 10-2005-0127214 filed Dec. 21, 2005 in the Korean Intellectual Property Office, the disclosure of which is incorporated herein by reference.

### BACKGROUND OF THE INVENTION

1. Field of the Invention

Apparatuses and methods consistent with the present invention relate to transmitting an ultra wideband (UWB) signal, and more particularly, to transmitting an multi band (MB)-orthogonal frequency division multiplexing (OFDM)-based UWB signal over a pipeline including a coaxial cable and a splitter and carrying a cable television (CATV) broadcasting signal using a frequency spread.

2. Description of the Related Art

Wireless devices have been popularized with the rapid development of wireless communication technology, which changes life styles of people. In particular, UWB communications have been briskly studied so as to coexist with existing wireless communication services and enable wireless communications in a high wide band without securing additional frequency resources. Also, interests in home networks have been highly increased, which has developed home network technology. As a result, various techniques for wireline and/or wireless home networking in homes have been suggested.

As a representative example, U.S. Pat. Application Publication No. 2005-0034159 discloses a method of interfacing a coaxial-based wireline network to a wireless local area network (LAN)-based network according to IEEE 802.11 standards for a home video network. Here, a wireless LAN signal according to IEEE 802.11 standards is transmitted to a coaxial cable without being converted. However, this method cannot be applied to an UWB signal that has been discussed by IEEE 802.15.3a. In other words, a transmission speed of 100 Mbps or more is required to transmit high-quality moving pictures in real-time. In this case, wireless UWB technology can be used, but a wireless UWB signal cannot be transmitted to a coaxial cable as it

FIG. 1 is a graph illustrating a spectrum of a wireless UWB signal in a transmission frequency band between 3 GHz and 10 GHz defined by the federal communications commission (FCC). FIG. 2 is a graph illustrating a frequency response with respect to a transmission attenuation characteristic, i.e., a transmission loss of 30 dB or more of a wireless UWB signal in a frequency band between 3 GHz and 10 GHz in a coaxial cable having a length of 10 m.

FIG. 3 is a graph illustrating a transmission characteristic of a radio frequency (RF) splitter. As shown in FIG. 3, a loss caused by a transmission characteristic is greater than a loss caused by a reflection characteristic in a frequency band of an UWB signal between 3 GHz and 10 GHz. Thus, it is difficult to transmit the UWB signal through an RF splitter as it is.

However, an MB-OFDM-based UWB signal that has been discussed in IEEE 802.15.3a has been evaluated as having a high transmission performance in a multi-path interface environment such as a CATV pipeline in a home unlike the other analog and digital transmitting methods.

Thus, for a wireline and/or wireless home networking in a home, a method of further efficiently transmitting an MB-OFDM-based UWB signal is required to apply MB-OFDM transmission technology robust to such a multi-path interface to a pipeline carrying a CATV broadcasting signal.

### SUMMARY OF THE INVENTION

The present invention provides a method and an apparatus for transmitting a wireline single-band OFDM-based UWB signal over a pipeline carrying a CATV broadcasting signal so as to be robust to a multi-path interface.

The present invention also provides a method and an apparatus for transmitting a wireline single-band OFDM-based UWB signal over a pipeline carrying a CATV broadcasting signal so as to further extend transmission distance.

According to an aspect of the present invention, there is provided a method of transmitting an UWB signal, including: transforming a multimedia signal transmitted from a wireline and/or wireless multimedia device into a wireline UWB signal; transforming the wireline UWB signal into a single-band OFDM signal; and frequency-spreading the single-band OFDM signal according to a transmission rate.

When the single-band OFDM signal is frequency-spread, a frequency spread coefficient may vary according to the transmission rate.

The single-band OFDM signal may be frequency-spread in a frequency band between 0.9 GHz and 1.6 GHz.

According to another aspect of the present invention, there is provided an apparatus for transmitting an UWB signal, including: a signal transformer which transforms a multimedia signal transmitted from a multimedia device into a wireline UWB signal; a single-band OFDM generator which transforms the wireline UWB signal into a single-band OFDM signal; and a frequency spreader which frequency-spreads the single-band OFDM signal according to a transmission rate.

The frequency spreader may vary a frequency spread coefficient according to the transmission rate.

The frequency spreader may frequency-spread the single-band OFDM signal in a frequency band between 0.9 GHz and 1.6 GHz.

According to another aspect of the present invention, there is provided an apparatus for transmitting an UWB signal, including: a module which transforms a multimedia signal transmitted from a multimedia device into a wireline UWB signal; a module which transforms the wireline UWB signal into a single-band OFDM signal; and a module which frequency-spreads the single-band OFDM signal according to a transmission rate.

According to another aspect of the present invention, there is provided a system for transmitting an UWB signal, including: a coaxial cable which transmits a CATV broadcasting signal; a splitter which is connected to the coaxial cable and splits the CATV broadcasting signal in a predetermined ratio; and an UWB signal transmission apparatus which is connected to the splitter and transmits a frequency-spread UWB signal to the splitter.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a graph illustrating a spectrum of an UWB signal;

FIG. 2 is a graph illustrating a frequency response with respect to a transmission attenuation characteristic of a coaxial cable;

FIG. 3 is a graph illustrating a transmission characteristic of an RF splitter;

FIG. 4 is a view illustrating a wireline UWB signal transmission system adopting an UWB signal transmission apparatus according to an exemplary embodiment of the present invention;

FIG. 5 is a block diagram of an UWB signal transmission apparatus according to an exemplary embodiment of the present invention;

FIG. 6 is a view illustrating a frequency spread according to an exemplary embodiment of the present invention;

FIG. 7 is a flowchart of a method of transmitting an UWB signal according to an exemplary embodiment of the present invention; and

FIG. 8 is a graph illustrating a performance of a method of transmitting an UWB signal according to an exemplary embodiment of the present invention.

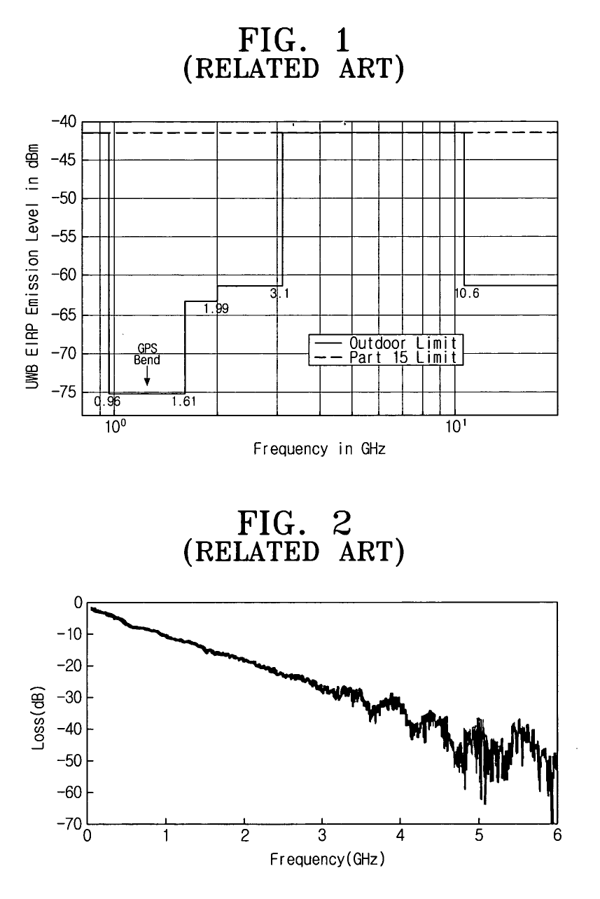

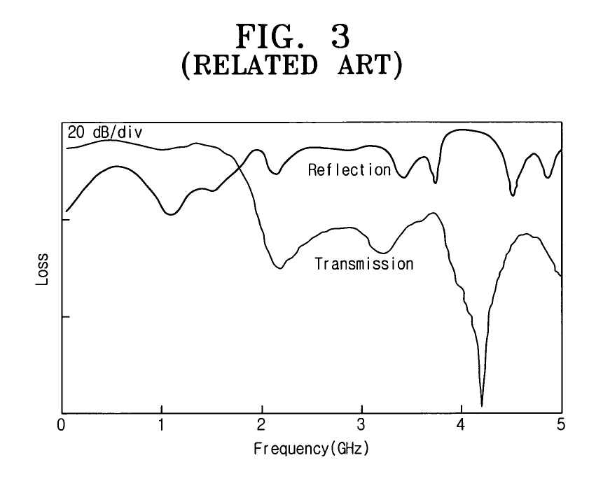

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

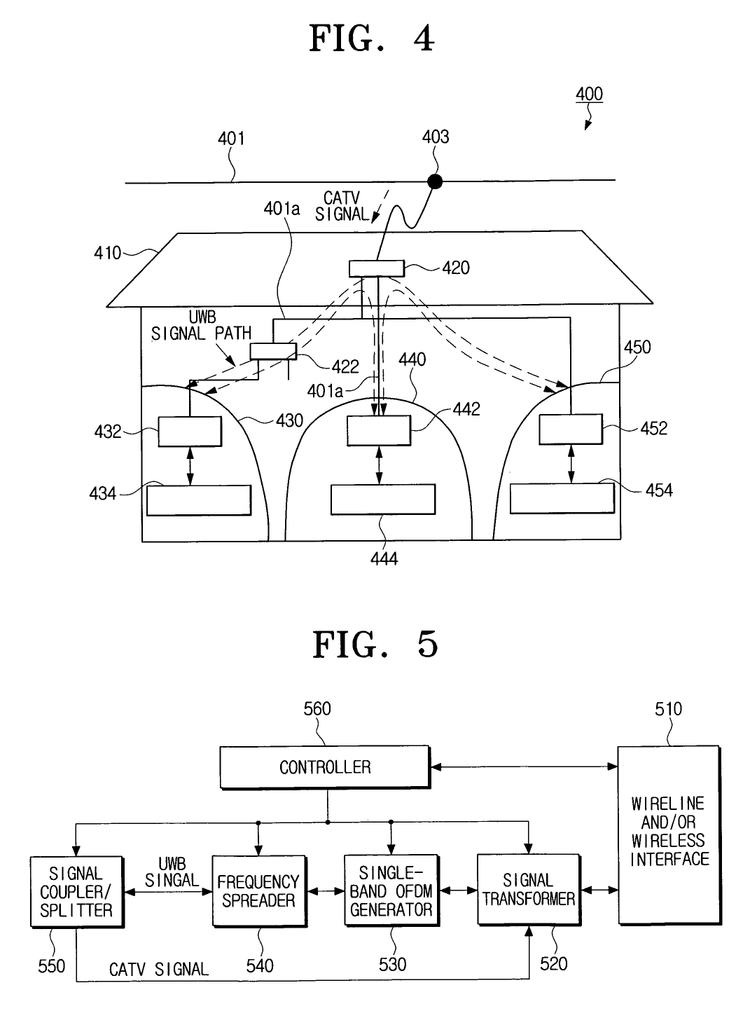

FIG. 4 is a view illustrating a wireline UWB signal transmission system adopting an UWB signal transmission apparatus according to an exemplary embodiment of the present invention.

The present exemplary wireline UWB signal transmission system transmits a wireline single-band OFDM-based UWB signal, which is robust to a multi-path interface, over a pipeline carrying a CATV broadcasting signal. Here, the present wireline UWB signal transmission system uses a frequency spread depending on a transmission rate to improve transmission efficiency.

Referring to FIG. 4, a wireline UWB signal transmission system 400 includes a coaxial cable 401a positioned in each home and transmitting a CATV broadcasting signal received through a tap 403 connected to a coaxial cable 401, splitters 420 and 422 connected to the coaxial cable 401a to split the CATV broadcasting signal in a predetermined ratio, and a plurality of UWB signal transmission apparatuses 432, 442, and 452 respectively connected to pipelines including a plurality of coaxial cables and a plurality of splitters and carrying the CATV broadcasting signal.

For example, it is supposed that a movie stored on a wireline and/or wireless hard disc 444 in a living room 440 is played to be televiewed through a digital television (TV) 434 in an interior room 430. In this case, the movie stored on the wireline and/or wireless hard disc 444 is a high speed wireline and/or wireless multimedia signal and transmitted to the second UWB signal transmission apparatus 442. Here, the wireline and/or wireless multimedia signal may be transmitted in a format of IEEE 1394, USB, Ethernet, or the like.

The second UWB signal transmission apparatus 442 transforms the wireline and/or wireless multimedia signal into a wireline single-band OFDM-based UWB signal and spreads a frequency of the wireline single-band OFDM-based UWB signal.

The wireline single-band OFDM-based UWB signal having the spread frequency is transmitted through the coaxial cable 401a and the splitters 420 and 422 to the first UWB signal transmission apparatus 432. Here, the wireline single-band OFDM-based UWB signal having the spread frequency is generally transmitted in an unused frequency band of a coaxial cable between 54 MHz and 862 MHz used for transmitting a CATV signal, for example, between 0.9 GHz and 1.6 GHz.

The first UWB signal transmission apparatus 432 inverse transforms the wireline single-band OFDM-based UWB signal into a wireline and/or wireless multimedia signal according to IEEE 1394, USB, Ethernet, or the like and transmits the wireline and/or wireless multimedia signal to the digital TV 434.

The CATV broadcasting signal transmitted through the coaxial cable 401 is transmitted through the tap 403 and the splitter 420 to the third UWB transmission apparatus 452, and the third UWB transmission apparatus 452 transmits the CATV broadcasting signal to a settop box 454 carrying an additional CATV broadcasting.

FIG. 5 is a block diagram of an UWB signal transmission apparatus according to an exemplary embodiment of the present invention. Referring to FIG. 5, the present UWB signal transmission apparatus includes a wireline and/or wireless interface 510, a signal transformer 520, a single-band OFDM generator 530, a frequency spreader 540, a signal coupling and/or splitter 550, and a controller 560.

The wireline and/or wireless interface 510 is connected to a plurality of wireline and/or wireless multimedia household appliances so as to offer an interface for transmitting and/or receiving a wireline and/or wireless multimedia signal. Examples of the wireline and/or wireless multimedia household appliances include the digital TV 434, the hard disc 444, the settop box 454, a personal video recorder (PVR), a speaker, and a personal computer (PC), and the wireline and/or wireless multimedia household appliances transmit and/or receive the wireline and/or wireless multimedia signal in a format of IEEE 1394, USB, Ethernet, or the like.

The signal transformer 520 inter-transforms the wireline UWB signal and the wireline and/or wireless multimedia signal.

The single-band OFDM generator 530 transforms the wireline UWB signal transformed by the signal transformer 520 to a single-band OFDM-based signal. The frequency spreader 540 frequency-spreads the single-band OFDM-based signal according to a transmission rate as in Equation 1:

$${C}_{n + 100 \frac{l}{L}} = {f}_{l} ( {d}_{n} ) , 0 \leq l \leq L - 1 \\ {f}_{l} ( {d}_{n} ) = {d}_{n} , if l = 0 , … , \frac{L}{2} - 1 \\ {f}_{l} ( {d}_{n} ) = {d}_{100 \frac{1}{L} - 1 - n}^{*} , if l = \frac{L}{2} , … , L , \qquad ( 1 )$$

wherein L denotes a frequency spread coefficient. The frequency spreader 540 obtains an L^{th} diversity effect with L using Equation 1. In other words, the frequency spreader 540 frequency-spreads the same signal in a band (bandwidth) between 0.9 GHz and 1.6 GHz and transmits the same signal L times. For example, if L is “2” in Equation 1, the frequency spreader 540 may use 100 different frequencies, where data is transmitted twice using each 50 frequencies. Here, data positioned in 0^{th} through 49^{th} frequencies (sub-carriers) and data positioned in 50^{th} through 99^{th} frequencies are in a conjugate relation.

In detail, the frequency spread technology is to repeatedly transmit a Quadrature Phase Shift Keying (QPSK) symbol within an OFDM symbol. In a case where separate sub-channels are unrelated channels in the frequency spread technology, frequency diversity can be obtained in a single OFDM symbol. Also, a symmetric conjugate process is performed as in Equation 1 so that an output value of Inverse Discrete Fourier Transform (IDFT) is constantly a real value. Thus, complexity of a transmitter is reduced. In addition, the frequency spread technology can be simply changed without reduction in a data transmission rate to obtain a higher diversity effect.

The signal coupler and/or splitter 550 is connected to a pipeline carrying a CATV broadcasting signal so as to couple the CATV broadcasting signal to a wireline UWB signal and/or split the CATV broadcasting signal from the wireline UWB signal.

The controller 560 controls operations of the wireline and/or wireless interface 510, the signal transformer 520, the single-band OFDM generator 530, the frequency spreader 540, and the signal coupler and/or splitter 550.

It has been described that wireline and/or wireless multimedia household appliances transmit wireline and/or wireless multimedia signals to describe the operation of an UWB signal transmission apparatus. Thus, the UWB signal transmission apparatus performs an inverse operation to receive the wireline and/or wireless multimedia signals.

FIG. 6 is a view illustrating a frequency spread according to an exemplary embodiment of the present invention. Referring to FIG. 6, a QPSK signal modulated by the single-band OFDM generator 530 is frequency-spread as in Equation 1.

In detail, the QPSK signal is input to a serial (S)/parallel (P) 610 in the unit of 128 frequencies. A spreader 620 frequency-spreads a signal input in parallel through the S/P 610 using Equation 1. Here, the spreader 620 varies a frequency spread coefficient L depending on a transmission rate of 100 Mbps or more, for example, transmission of 110 Mbps or 160 Mbps. An IDFT 630 transforms the frequency-spread signal into time domain sampling signals and then sums the time domain sampling signals so as to generate an OFDM signal. A parallel (P)/serial (S) 640 outputs the OFDM signal in series. Thus, the frequency-spread signal has a conjugate characteristic and thus is output as a signal having only a real value. Also, L^{th} diversity can be obtained through L^{th} spread in a frequency domain.

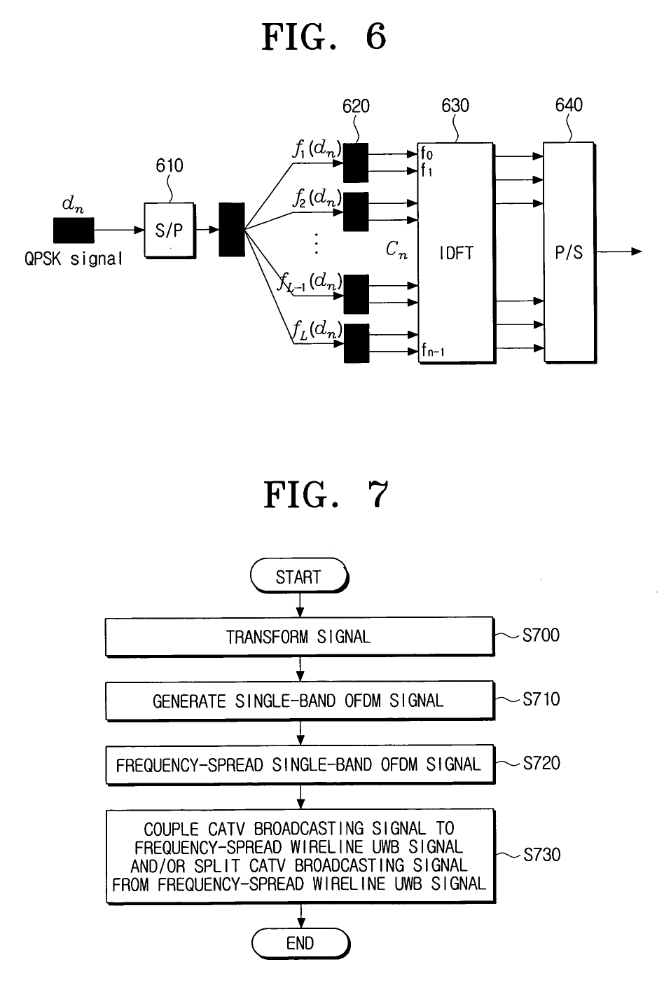

FIG. 7 is a flowchart of a method of transmitting an UWB signal according to an exemplary embodiment of the present invention. Referring to FIG. 7, in operation S700, the signal transformer 520 inter-transforms a wireline UWB signal and a wireline and/or wireless multimedia signal. In detail, the signal transformer 520 transforms the wireline and/or wireless multimedia signal into the wireline UWB signal during transmission and the wireline UWB signal into the wireline and/or wireless multimedia signal during reception.

In operation S710, the single-band OFDM generator 530 transforms the wireline UWB signal transformed by the signal transformer 520 into a single-band OFDM signal. In operation S720, the frequency spreader 540 frequency-spreads the single-band OFDM signal generated by the single-band OFDM generator 530. In other words, in a coaxial cable where a single frequency band is used, a channel hardly varies temporally. Thus, if time spread is applied in a coaxial cable, a diversity effect cannot be obtained. As a result, operation S720 is performed so as to obtain a diversity effect.

In operation S730, the signal coupler and/or splitter 550 couples a CATV broadcasting signal to the frequency-spread wireline UWB signal and/or splits the CATV broadcasting signal from the frequency-spread wireline UWB signal. In detail, the signal coupler and/or splitter 550 couples the CATV broadcasting signal to the frequency-spread wireline UWB signal during the transmission and/or splits the CATV broadcasting signal from the frequency-spread wireline UWB signal during the reception.

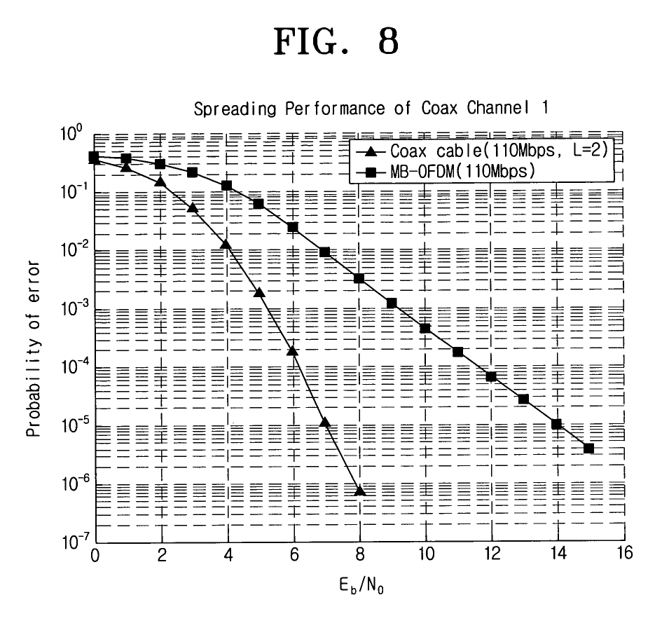

FIG. 8 is a graph illustrating a performance of a method of transmitting an UWB signal according to an exemplary embodiment of the present invention. Referring to FIG. 8, performances of an 110 Mbps MB-OFDM method using time spread in a coaxial cable and an 110 Mbps single-band OFDM method using a frequency spread in the coaxial cable are shown. The horizontal axis denotes a signal-to-noise ratio (SNR) E_{b}/N₀, and the vertical axis denotes probability of an error. Here, a frequency spread coefficient L of the 110 Mbps single-band OFDM method using the frequency spread is “2.”

Here, if the probability of the error is 10⁻⁵, the SNR of the 110 Mbps MB-OFDM method using the time spread is about 13 dB. If the probability of the error is 10⁻⁵, the SNR of the 110 Mbps single-band OFDM method using the frequency spread is about 7 dB. In other words, the 110 Mbps MB-OFDM method using the time spread and the 110 Mbps single-band OFDM method using the frequency spread has a SNR difference of about 6 dB in the same probability of the error. This means that the 110 Mbps single-band OFDM method using the frequency spread has a higher transmission rate than the 110 Mbps MB-OFDM method using the time spread in the same probability of the error. In detail, the 110 Mbps single-band OFDM method using the frequency spread has more extended transmission distance than the 110 Mbps MB-OFDM method using the time spread in the same probability of the error. Also, the 110 Mbps single-band OFDM method using the frequency spread has remarkably reduced error probability than the 110 Mbps MB-OFDM method using the time spread in the same SNR.

As described above, according to exemplary embodiments of the present invention, an UWB signal transmission apparatus can be robust to multi-path interference and further extend transmission distance. Thus, transmission efficiency can be increased.

Also, an L^{th} diversity effect can be obtained through L^{th} spread in a frequency domain. The UWB signal transmission apparatus can include only a real component due to a conjugate symmetric characteristic caused by a frequency spread. Thus, complexity of the UWB signal transmission apparatus can be reduced. In addition, the UWB signal transmission apparatus can use time and frequency spread at a low transmission rate without reduction in a transmission rate.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of transmitting an ultra wideband (UWB) signal, the method comprising:
transforming a multimedia signal transmitted from a multimedia device into a wireline UWB signal;
transforming the wireline UWB signal into a single-band orthogonal frequency division multiplexing (OFDM) signal; and
frequency-spreading the single-band OFDM signal according to a transmission rate.

2. The method of claim 1, wherein when the single-band OFDM signal is frequency-spread, a frequency spread coefficient used in the frequency-spreading varies according to the transmission rate.

3. The method of claim 1, wherein the single-band OFDM signal is frequency-spread in a frequency band between 0.9 GHz and 1.6 GHz.

4. The method of claim 1, further comprising coupling cable TV broadcasting signal to the frequency-spread single-band OFDM signal.

5. The method of claim 1, the transmission rate is 100 Mbps or more.

6. An apparatus for transmitting an ultra wideband (UWB) signal, comprising:
a signal transformer which transforms a multimedia signal transmitted from a multimedia device into a wireline UWB signal;
a single-band orthogonal frequency division multiplexing (OFDM) generator which transforms the wireline UWB signal into a single-band OFDM signal; and
a frequency spreader which frequency-spreads the single-band OFDM signal according to a transmission rate.

7. The apparatus of claim 6, wherein the frequency spreader varies a frequency spread coefficient used in the frequency-spreading according to the transmission rate.

8. The apparatus of claim 6, wherein the frequency spreader frequency-spreads the single-band OFDM signal in a frequency band between 0.9 GHz and 1.6 GHz.

9. The apparatus of claim 6, further comprising a signal coupler and splitter which couples a cable television broadcasting signal to the frequency-spread single-band OFDM signal.

10. The apparatus of claim 6, the transmission rate is 100 Mbps or more.

11. The apparatus of claim 6, the signal-transformer is configured to intertransform the multimedia signal and the wireline UWB signal.

12. An apparatus for transmitting an ultra wideband (UWB) signal, the apparatus comprising:
a module which transforms a multimedia signal transmitted from a multimedia device into a wireline UWB signal;
a module which transforms the wireline UWB signal into a single-band orthogonal frequency division multiplexing (OFDM) signal; and
a module which frequency-spreads the single-band OFDM signal according to a transmission rate.

13. The apparatus of claim 12, wherein the module, which frequency-spreads the single-band OFDM signal according to the transmission rate, varies a frequency spread coefficient used in the frequency-spreading according to the transmission rate.

14. The apparatus of claim 12, wherein the module, which frequency-spreads the single-band OFDM signal according to the transmission rate, frequency-spreads the single-band OFDM signal in a frequency band between 0.9 GHz and 1.6 GHz.

15. The apparatus of claim 12, further comprising a module which couples a cable television broadcasting signal to the frequency-spread single-band OFDM signal.

16. The apparatus of claim 12, the transmission rate is 100 Mbps or more.

17. The apparatus of claim 12, the module, which transforms the multimedia signal transmitted from the multimedia device into the wireline UWB signal, is configured to intertransform the multimedia signal and the wireline UWB signal.

18. A system for transmitting an ultra wideband (UWB) signal, comprising:
a coaxial cable which transmits a cable television (CATV) broadcasting signal;
a splitter which is connected to the coaxial cable and splits the CATV broadcasting signal in a predetermined ratio; and
an UWB signal transmission apparatus which is connected to the splitter and transmits a frequency-spread UWB signal to the splitter.

19. The system of claim 18, wherein the UWB signal transmission apparatus comprising:
a signal transformer which transforms a multimedia signal transmitted from a multimedia device into a wireline UWB signal;
a single-band orthogonal frequency division multiplexing (OFDM) generator which transforms the wireline UWB signal into a single-band OFDM signal; and
a frequency spreader which frequency-spreads the single-band OFDM signal according to a transmission rate.

20. The apparatus of claim 19, wherein the frequency spreader varies a frequency spread coefficient used in the frequency-spreading according to the transmission rate.

21. The apparatus of claim 19, wherein the frequency spreader frequency-spreads the single-band OFDM signal in a frequency band between 0.9 GHz and 1.6 GHz.

22. The apparatus of claim 19, further comprising a signal coupler and splitter which couples the CATV broadcasting signal to the frequency-spread single-band OFDM signal.

23. The apparatus of claim 19, the transmission rate is 100 Mbps or more.

24. The apparatus of claim 19, the signal-transformer is configured to intertransform the multimedia signal and the wireline UWB signal.
